(19) United States
(12) Patent Application Publication
(10) Pub. No.: US 2009/0096730 A1
(43) Pub. Date: Apr. 16, 2009

(54) DISPLAY SUBSTRATE, DISPLAY DEVICE HAVING THE SAME AND METHOD OF DRIVING THE SAME

(76) Inventors: Mee-Hye JUNG, Gyeonggi-do (KR); Kyoung-Ju Shin, Gyeonggi-do (KR); Hee-Seop Kim, Gyeonggi-do (KR); Young-Chol Yang, Gyeonggi-do (KR); Chong-Chul Chai, Geonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 12/211,627

(22) Filed: Sep. 16, 2008

(30) Foreign Application Priority Data
Oct. 10, 2007 (KR) 2007-102222

(51) Int. Cl. G09G 3/36; G02F 1/136

(52) U.S. Cl. 345/87; 349/39

(57) ABSTRACT

A display substrate includes first and second storage electrodes, a pixel electrode and a direction control electrode. A slit is formed through the pixel electrode. The direction control electrode is positioned in a region aligned with the slit, and a level of a voltage applied to the direction control electrode is changed. The level of the voltage applied to the direction control electrode may be periodically changed. The voltage applied to the direction control electrode may be changed after substantially the same voltage is applied to the pixel electrode and the direction control electrode. A voltage difference between a reference voltage and the direction control voltage may be greater than a voltage difference between the reference voltage and the pixel voltage. The reference voltage may be a common voltage.

### CROSS-REFERENCE TO RELATED APPLICATIONS

The present application claims priority under 35 U.S.C. §119 to Korean Patent Application No. 10-2007-102222, filed on Oct. 10, 2007 in the Korean Intellectual Property Office (KIPO), the contents of which are herein incorporated by reference in their entirety.

### BACKGROUND OF THE INVENTION

1. Field of the Invention

The present invention relates to a display substrate, a display device having the display substrate and a method of driving the display device. More particularly, the present invention relates to a display substrate capable of forming a multi-domain, a display device having the display substrate and a method of driving the display device.

2. Description of the Related Art

A liquid crystal display (LCD) device, in general, includes an upper display substrate, a lower display substrate and a liquid crystal layer. The upper display substrate typically includes a common electrode, and a color filter. The lower display substrate typically includes a thin film transistor, and a pixel electrode. The liquid crystal layer is interposed between the upper display substrate and the lower display substrate. The orientation of liquid crystal molecules in the liquid crystal layer interposed between the pixel electrode and the common electrode is controlled in response to an electric field formed between the pixel electrode and the common electrode. Thus, light transmittance of the liquid crystal layer is changed.

The LCD device may have a vertical alignment (VA) mode. In the VA mode, the liquid crystal molecules are vertically aligned with respect to the upper display substrate and the lower display substrate, when no electric field is formed between the pixel electrode and the common electrode.

In an LCD device of the VA mode type, a multi-domain is established by using a slit or a protrusion formed in the pixel electrode or the common electrode. The multi-domain increases a viewing angle of the LCD device. Thus, an LCD device of the VA mode type is widely used.

However, the slit of the pixel electrode or the common electrode is formed through an additional patterning process, and a colorant of the color filter may leak through the slit to pollute the liquid crystal layer. In addition, the protrusion is also formed through an additional process, and the protrusion changes light transmittance with respect to a remainder of the LCD device, thereby deteriorating a contrast ratio.

### SUMMARY OF THE INVENTION

The present invention provides a display substrate capable of forming a multi-domain without forming a slit of a common electrode or a protrusion to increase a viewing angle of a liquid crystal display (LCD) device.

The present invention also provides a display device having the above-mentioned display substrate to increase the viewing angle.

The present invention also provides a method of driving the above-mentioned display device.

A display substrate in accordance with an aspect of the present invention includes first and second storage electrodes, a pixel electrode and a direction control electrode. A slit is formed through the pixel electrode. The direction control electrode is formed in a region corresponding to the slit, and a level of a voltage applied to the direction control electrode is changed. The level of the voltage applied to the direction control electrode may be periodically changed. The voltage applied to the direction control electrode may be changed, after substantially the same voltage is applied to the pixel electrode and the direction control electrode. A voltage difference between a reference voltage and the direction control voltage may be greater than a voltage difference between the reference voltage and the pixel voltage. The reference voltage may be a common voltage.

A display substrate in accordance with another aspect of the present invention includes a pixel electrode and a direction control electrode. A slit is formed through the pixel electrode. The direction control electrode is formed in a region corresponding to the slit, and is overlapped with a storage electrode. The direction control electrode may be on the storage electrode. An insulating layer may be interposed between the storage electrode and the direction control electrode. A level of a voltage applied to the direction control electrode may be changed based on a variation of a voltage applied to the storage electrode. Alternatively, the voltage applied to the pixel electrode may not be changed, or an amount of the variation of the voltage applied to the pixel electrode may be smaller than that of the voltage applied to the direction control electrode.

A display substrate in accordance with still another aspect of the present invention includes a pixel electrode and a direction control electrode. The pixel electrode is overlapped with a plurality of storage electrodes, and a slit is formed through the pixel electrode. The direction control electrode is formed in a region corresponding to the slit, and is overlapped with one of the storage electrodes. The direction control electrode may be formed on the one of the storage electrodes. Storage voltages having opposite phases may be applied to the storage electrodes.

A display substrate in accordance with further still another aspect of the present invention includes first and second storage electrodes, first and second sub-pixel electrodes, a first direction control electrode and a second direction control electrode. The first and second sub-pixel electrodes are overlapped with the first and second storage electrodes, and first and second slits are formed through the first and second sub-pixel electrodes, respectively. The first direction control electrode is formed in a region corresponding to the first slit, and is overlapped with a first electrode of the first and second storage electrodes. The second direction control electrode is formed in a region corresponding to the second slit, and is overlapped with a second electrode of the first and second storage electrodes.

A display device in accordance with further still another aspect of the present invention includes a first substrate, a second substrate and a liquid crystal layer. The first substrate includes first and second storage electrodes, a pixel electrode and a direction control electrode. The pixel electrode is overlapped with the first and second storage electrodes, and a slit is formed through the pixel electrode. The direction control electrode is formed in a region corresponding to the slit, and is overlapped on the second storage electrode. The second substrate corresponds to the first substrate, and includes a common electrode. The liquid crystal layer is interposed between the first and second substrates, and is vertically aligned when an electric field is not applied to the liquid crystal layer.

A method of driving a display device in accordance with further still another aspect of the present invention is provided as follows. A pixel voltage is applied to a pixel electrode having a slit and a direction control electrode formed in a region corresponding to the slit. Levels of a first storage voltage applied to a first storage electrode and a second storage voltage applied to a second storage electrode are changed. The first and second storage electrodes are overlapped with the pixel electrode. A level of a voltage applied to the direction control electrode is changed in response to a variation of the second storage voltage applied to the second storage electrode.

Before the second storage voltage is changed, the pixel voltage may have an opposite polarity to the second storage voltage with respect to a reference voltage. After the second storage voltage is changed, the pixel voltage may have substantially the same polarity to the second storage voltage with respect to the reference voltage.

The pixel electrode and the direction control electrode may comprise a transparent conductive material and an opaque conductive material, respectively, and the pixel electrode may be formed from a different layer from the direction control electrode. The pixel electrode and the direction control electrode may comprise a transparent conductive material, and the pixel electrode may be formed from a same layer as the direction control electrode. The pixel electrode may have a plurality of slits, and the direction control electrode may be formed in a region corresponding to a portion of the slits. The direction control electrode may not be formed on a remainder of the slits. An end of the direction control electrode may be surrounded by the pixel electrode.

The present invention may, however, be embodied in many different forms and should not be construed as limited to the embodiments set forth herein.

According to the present invention, a voltage difference between the direction control voltage and a reference voltage is greater than a voltage difference between the pixel voltage and the reference voltage. Thus, a viewing angle of the display device may be increased, although the display device does not require a slit in the common electrode or a protrusion.

### BRIEF DESCRIPTION OF THE DRAWINGS

The above and other advantages of the present invention will become more apparent in light of the following detailed description of example embodiments thereof with reference to the accompanying drawings, in which:

FIG. 1 is a perspective view illustrating a display device in accordance with a first embodiment of the present invention;

FIG. 2 is a combination pictorial and circuit diagram illustrating the display device shown in FIG. 1;

FIG. 3 is an equivalent circuit diagram illustrating a display device in accordance with a second embodiment of the present invention;

FIG. 4 is an equivalent circuit diagram illustrating a display device in accordance with a third embodiment of the present invention;

FIG. 5 is a plan view illustrating a display device in accordance with a fourth embodiment of the present invention;

FIG. 6 is a cross-sectional view illustrating taken along line VII-VII′ shown in FIG. 5;

FIG. 7 is a cross-sectional view illustrating taken along line VIII-VIII′ shown in FIG. 5;

FIG. 8 is a plan view illustrating a display device in accordance with a fifth embodiment of the present invention; and

FIG. 9 is a timing diagram illustrating signals applied to a display device in accordance with one embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention is described in detail with reference to the accompanying drawings.

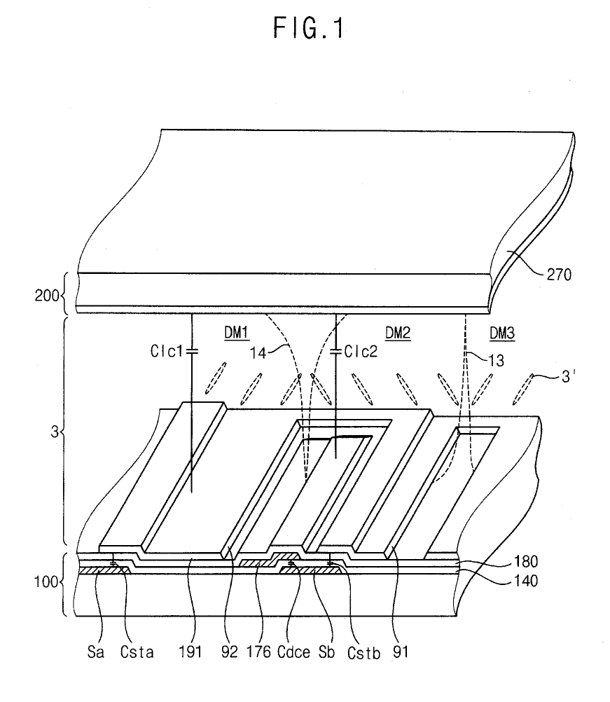

FIG. 1 is a perspective view illustrating a display device in accordance with a first embodiment of the present invention.

Referring to FIG. 1, the display device is a liquid crystal display (LCD) device including a lower display substrate 100, an upper display substrate 200 and a liquid crystal layer 3. The lower display substrate 100 faces the upper display substrate 200. The liquid crystal layer 3 is interposed between the lower display substrate 100 and the upper display substrate 200. The LCD device may further include a gate driving part (not shown) applying a gate signal to the lower display substrate 100, a data driving part (not shown) applying a data signal to the lower display substrate 100, a storage capacitor driving part (not shown) applying a storage voltage to the lower display substrate 100, and a control signal part (not shown) generating control signals for controlling the gate driving part, the data driving part and the storage capacitor driving part.

In FIG. 1, the liquid crystal layer 3 interposed between a pixel electrode 191 and a common electrode 270 and between a direction control electrode 176 and the common electrode 270 includes nematic liquid crystal molecules 3′. The nematic liquid crystal molecules 3′ have negative dielectric anisotropy and are vertically aligned. A longitudinal direction of the nematic liquid crystal molecules 3′ having the negative dielectric anisotropy is aligned substantially perpendicular to an electric field. Therefore, an arrangement of the nematic liquid crystal molecules 3′ may be controlled by controlling a direction of the electric field. The direction of the electric field in a region among a plurality of regions may be different from one another, so that a plurality of domains DM1, DM2 and DM3 may be formed on the pixel electrode 191. The nematic liquid crystal molecules 3′ are aligned in various directions in the domains DM1, DM2 and DM3.

In order to form the domains DM1, DM2 and DM3 on the pixel electrode 191, the direction control electrode 176 is formed in a first slit 91 and a second slit 92. In addition, a voltage difference between the direction control electrode 176 and the common electrode 270 is greater than a voltage difference between the pixel electrode 191 and the common electrode 270. For example, a greater voltage is applied to the direction control electrode 176 that is surrounded by the second slit 92, so that an electric field 14 formed between the direction control electrode 176 and the common electrode 270 is different from an electric field 13 formed on the first slit 91. Thus, the domains may be formed in the LCD device without a slit formed in the common electrode 270 or a protrusion.

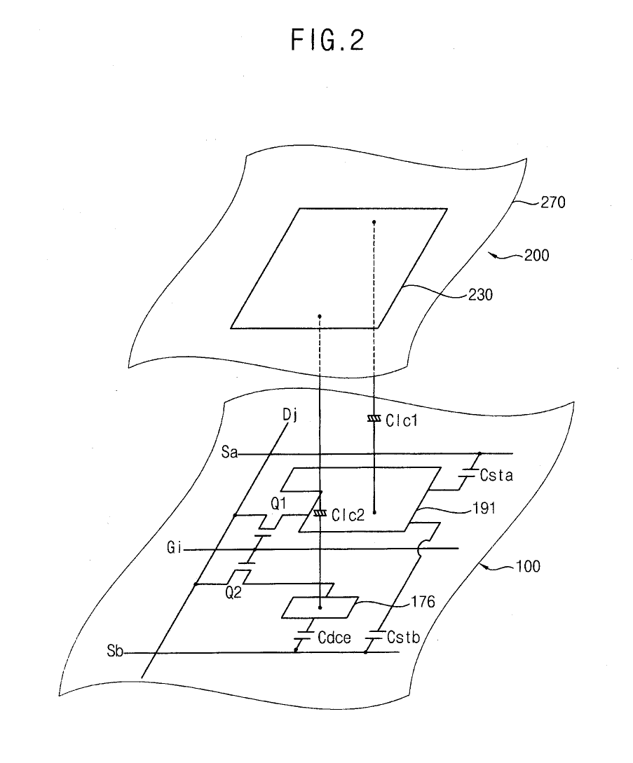

FIG. 2 is a combination pictorial and circuit diagram illustrating the pixel electrode 191 and the direction control electrode 176 of the display device shown in FIG. 1.

Referring to FIGS. 1 and 2, the LCD device may further include signal lines. The signals lines include a gate line Gi transmitting the gate signal, a data line Dj transmitting the data signal, and first and second storage lines Sa and Sb transmitting a storage voltage. For example, a plurality of gate lines Gi and a plurality of data lines Dj may be repetitively formed on the lower display substrate 100. The gate lines Gi are extended in a column direction, and are substantially parallel with each other. The data lines Dj are extended in a row direction, and are substantially parallel with each other. Alternatively, the gate lines Gi may be extended in the row direction, and the data lines Dj may be extended in the column direction.

The LCD device may further include a plurality of pixels. Each of the pixels includes a first switching element Q1, a second switching element Q2, a first liquid crystal capacitor Clc1, a first storage capacitor Csta, a second storage capacitor Cstb, a second liquid crystal capacitor Clc2 and a direction control capacitor Cdce. Each of the first and second switching elements Q1 and Q2 is electrically connected to one of the gate lines Gi and one of the data lines Dj. The first liquid crystal capacitor Clc1 is electrically connected to the first switching element Q1. The second liquid crystal capacitor Clc2 is electrically connected to the second switching element Q2.

Each of the first and second switching elements Q1 and Q2 may include a thin film transistor formed on the lower display substrate 100. A control electrode, an input electrode and an output electrode of the first switching element Q1 are electrically connected to one of the gate lines Gi, one of the data lines Dj and the first liquid crystal capacitor CLC1, respectively. A control electrode, an input electrode and an output electrode of the second switching element Q2 are electrically connected to one of the gate lines Gi, one of the data lines Dj and the second liquid crystal capacitor CLC2, respectively.

The first liquid crystal capacitor Clc1 is defined by the pixel electrode 191 of the lower display substrate 100, the common electrode 270 of the upper display substrate 200 and the liquid crystal layer 3. The second liquid crystal capacitor Clc2 is defined by the direction control electrode 176 of the lower display substrate 100, the common electrode 270 of the upper display substrate 200 and the liquid crystal layer 3. The liquid crystal layer 3 interposed between the pixel electrode 191 and the common electrode 270 and between the direction control electrode 176 and the common electrode 270 functions as dielectric material of the first and second liquid crystal capacitors Clc1 and Clc2. The pixel electrode 191 is electrically connected to the output electrode of the first switching element Q1, and the direction control electrode 176 is electrically connected to the output electrode of the second switching element Q2. The common electrode 270 is formed on an entire surface of the upper display substrate 200, and receives the common voltage Vcom.

The first storage line Sa of the lower display substrate 100 overlaps with a portion of pixel electrode 191, with gate insulating layer 140 and a passivation layer 180 formed therebetween, thereby forming the first storage capacitor Csta. The second storage line Sb of the lower display substrate 100 overlaps with a portion of pixel electrode 191, with gate insulating layer 140 and a passivation layer 180 formed therebetween, thereby forming the second storage capacitor Cstb. The second storage line Sb also overlaps with the direction control electrode 176, with gate insulating layer 140 interposed therebetween, thereby forming the direction control capacitor Cdce. Alternatively, one of the first and second storage lines Sa and Sb may be overlapped with the direction control electrode 176 to form the direction control capacitor Cdce. The storage voltages Vsta and Vstb are applied to the first and second storage lines Sa and Sb, respectively.

For example, the pixels may display different primary colors, respectively, through a space division method. Alternatively, the pixels may display the different primary colors, alternately, through a time division method. The primary colors may include red, green and blue. Alternatively, the primary colors may include red, green, blue and white. When the colors are displayed through the space division method, the upper display substrate 200 may include a plurality of color filters 230 corresponding to the pixel electrodes 191, respectively. Alternatively, the color filters 230 may be formed on the pixel electrode 191 or under the pixel electrode 191 of the lower display substrate 100. For example, the color filters 230 may include a red color filter, a green color filter and a blue color filter corresponding to the red, green and blue colors.

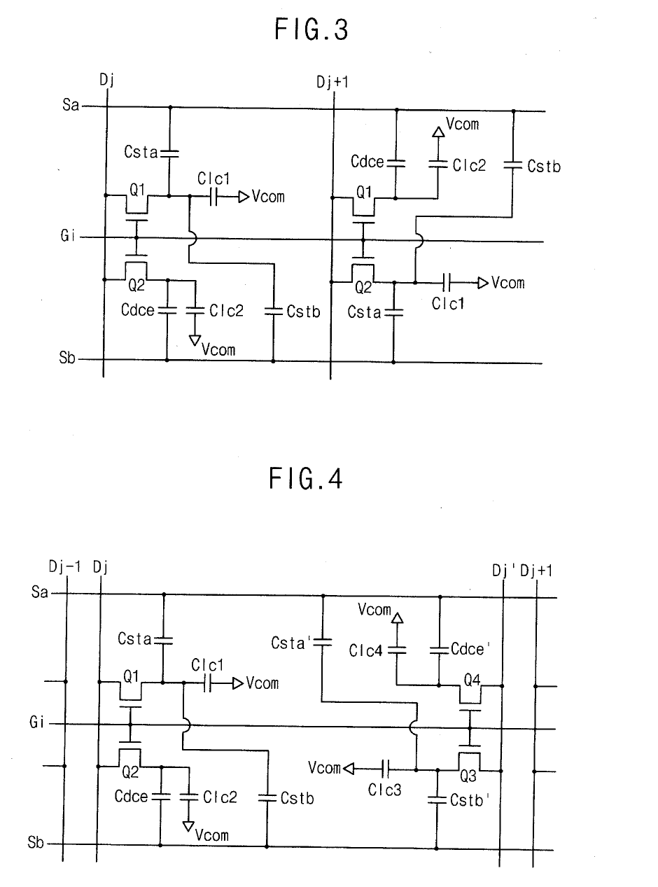

FIG. 3 is an equivalent circuit diagram illustrating a display device in accordance with a second embodiment of the present invention. FIG. 4 is an equivalent circuit diagram illustrating a display device in accordance with a third embodiment of the present invention.

Referring to FIGS. 3 and 4, adjacent pixels are alternately connected to first and second storage lines Sa and Sb. For example, when a direction control capacitor Cdce of a unit pixel is overlapped with the first storage line Sa, a direction control capacitor Cdce of an adjacent pixel is overlapped with the second storage capacitor Sb.

In FIG. 3, a first liquid crystal capacitor Clc1 and a second liquid crystal capacitor Clc2 may be formed on each of the pixels. Alternatively, in FIG. 4, a first liquid crystal capacitor Clc1 and a third liquid crystal capacitor Clc3 may be formed on a unit pixel, and a second liquid crystal capacitor Clc2 and a fourth liquid crystal capacitor Clc4 may be formed on an adjacent pixel. In FIG. 4, pixel voltages applied to the first and third liquid crystal capacitors Clc1 and Clc3 may have different levels. Alternatively, the pixel voltages applied to the first and third liquid crystal capacitors Clc1 and Clc3 may be electrically coupled.

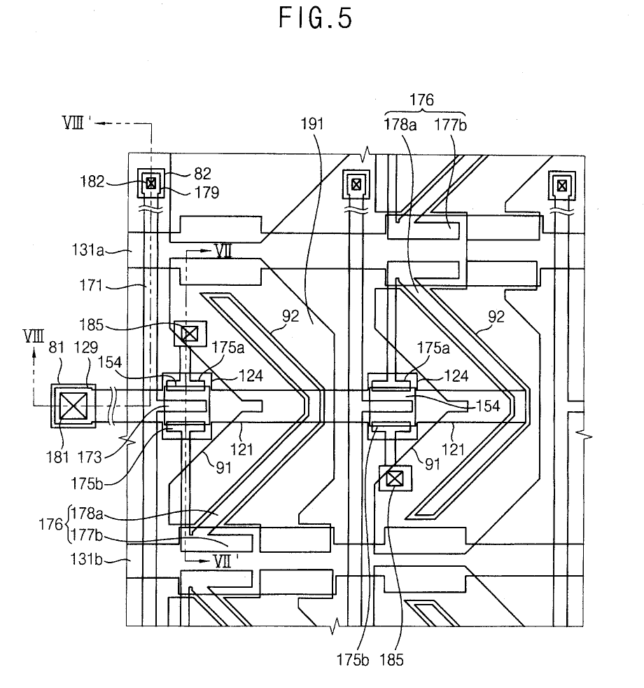

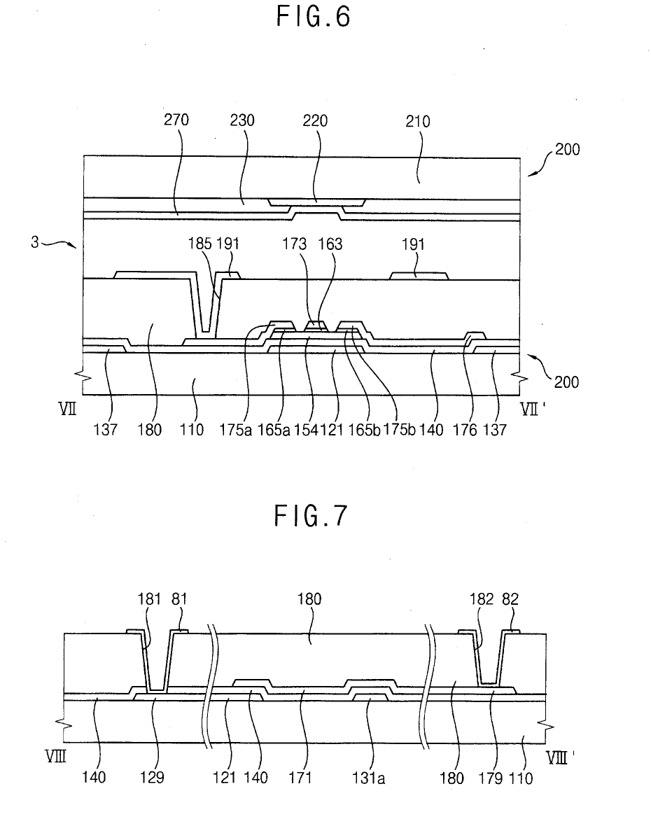

FIG. 5 is a plan view illustrating a display device in accordance with a fourth embodiment of the present invention. FIG. 6 is a cross-sectional view illustrating a line VII-VII′ shown in FIG. 5. FIG. 7 is a cross-sectional view illustrating a line VIII-VIII′ shown in FIG. 5.

In FIG. 5, the display device includes the lower display substrate 100 shown in FIG. 3.

Referring to FIGS. 5 to 7, the lower display substrate 100 includes an insulating substrate 110, a plurality of gate lines 121, first and second storage lines 131a and 131b, a plurality of data lines 171, a plurality of pixel electrodes 191 and a plurality of direction control electrodes 176. The insulating substrate 110 includes transparent glass or plastic.

The gate lines 121 are extended in a longitudinal direction, and transmit gate signals. Each of the gate lines 121 is electrically connected to a plurality of gate electrodes 124, and includes a pad portion 129 electrically connected to a gate driving part.

The first and second storage lines 131a and 131b receive voltages, and are substantially parallel with the gate lines 121. The first and second storage lines 131a and 131b are opposite to each other with respect to an adjacent gate line 121. The first and second storage lines 131a and 131b are electrically connected to a first storage electrode and a second storage electrode, respectively. The first and second storage lines 131a and 131b may have various shapes and arrangements. For example, the first and second storage lines 131a and 131b may be formed from a same layer as the gate lines 121.

Examples of a conductive material that may be used for the gate lines 121 and the first and second storage lines 131a and 131b include aluminum (Al), silver (Ag), copper (Cu), molybdenum (Mo), chromium (Cr), tantalum (Ta), titanium (Ti), an alloy thereof or an oxide thereof. Each of the gate lines 121 and the first and second storage lines 131a and 131b may have a mono-layered structure or a multi-layered structure.

A gate insulating layer 140 is formed on the insulating substrate 110 to cover the gate lines 121 and the first and second storage lines 131a and 131b. The gate insulating layer 140 may include silicon nitride (SiNx), silicon oxide (SiOx), etc.

A semiconductor layer 154 is formed on the gate insulating layer 140. The semiconductor layer 154 may include hydrogenated amorphous silicon (a-Si), polysilicon, etc.

An ohmic contact layer 165 is formed on the semiconductor layer 154. For example, N+ ions may be implanted on an upper portion of the semiconductor layer 154 to form the ohmic contact layer 165. The data lines 171 and first and second drain electrodes 175a and 175b are formed on the ohmic contact layer 165 and the gate insulating layer 140.

The data lines 171 are extended in a horizontal direction to transmit data signals. Each of the data lines 171 is electrically connected to a plurality of source electrodes 173, and includes a pad portion 179 electrically connected to a data driving part 400.

First and second drain electrodes 175a and 175b are electrically separated from each other, and are also separated from the data lines 171. The first and second drain electrodes 175a and 175b are opposite to each other with respect to each of the source electrodes 173.

The direction control electrode 176 includes an extended portion 177b and an electrode portion 178a. The extended portion 177b is formed on the second storage line 131b. The electrode portion 178a is protruded from the extended portion 177b. The electrode portion 178a is inclined with respect to the extended portion 177b, and is extended from the extended portion 177b toward a region adjacent to the first storage line 131a. The electrode portion 178a may form an angle of about 45 degrees or about 135 degrees with respect to the gate lines 121.

The direction control electrode 176 and the common electrode 270 of the upper display substrate 200 are used for electrodes of a second liquid crystal capacitor Clc2. The extended portion 177b of the direction control electrode 176 and the second storage line 131b are used for electrodes of a direction control capacitor Cdce.

Examples of a conductive material that may be used for the data lines 171 and the drain electrodes 175 include aluminum (Al), silver (Ag), copper (Cu), molybdenum (Mo), chromium (Cr), tantalum (Ta), titanium (Ti), an alloy thereof or an oxide thereof. Each of the data lines 171 and the drain electrodes 175 may have a mono-layered structure or a multi-layered structure.

A passivation layer 180 is formed on the gate insulating layer 140 to cover the data lines 171, the drain electrode 175 and the semiconductor layer 154. The passivation layer 180 may include an inorganic insulating material or an organic insulating material. Examples of the inorganic insulating material that may be used for the passivation layer 180 include silicon nitride, silicon oxide, etc.

The pad portions 179 of the gate and data lines 121 and 171 and the first drain electrodes 175a are exposed through a plurality of contact holes 181, 182 and 185 formed through the passivation layer 180 and/or the gate insulating layer 140.

A plurality of pixel electrodes 191 and a plurality of auxiliary pads 81 and 82 are formed on the passivation layer 180.

Each of the pixel electrodes 191 is electrically connected to each of the first drain electrodes 175a through the contact hole 185 on the pixel electrode 191 to receive the data voltage from the first drain electrode 175a.

The pixel electrode 191 and the first and second storage lines 131a and 131b form the first and second storage capacitors Csta and Cstb. For example, the pixel electrode 191 includes a transparent electrode having a transparent conductive material. Alternatively, the pixel electrode 191 may include a reflective electrode having a highly reflective metal. The pixel electrode 191 may also include a transflective electrode having a transparent electrode portion for a transmission mode and a reflective electrode portion for a reflection mode.

For example, a right corner of the pixel electrode 191 may be chamfered. The chamfered side of the pixel electrode 191 may form an angle of about 45 degrees or about 135 degrees. When the chamfered side of the pixel electrode 191 forms the angle of about 45 degrees or about 135 degrees, response speed of liquid crystal molecules 3′ (shown in FIG. 1) may be increased.

First and second slits 91 and 92 are formed through the pixel electrode 191. The second slit 92 is extended along the electrode portion 178a of the direction control electrode 176. The electrode portion 178a of the direction control electrode 176 is in a region corresponding to the second slit 92.

The first and second slits 91 and 92 may form an inversion symmetry with respect to the gate line 121 that divides the pixel electrode 191.

Alignment layers (not shown) may be formed on inner surfaces between the lower and upper display substrates 100 and 200. At least one polarizer (not shown) may be formed on an outer surface of the lower and upper display substrates 100 and 200.

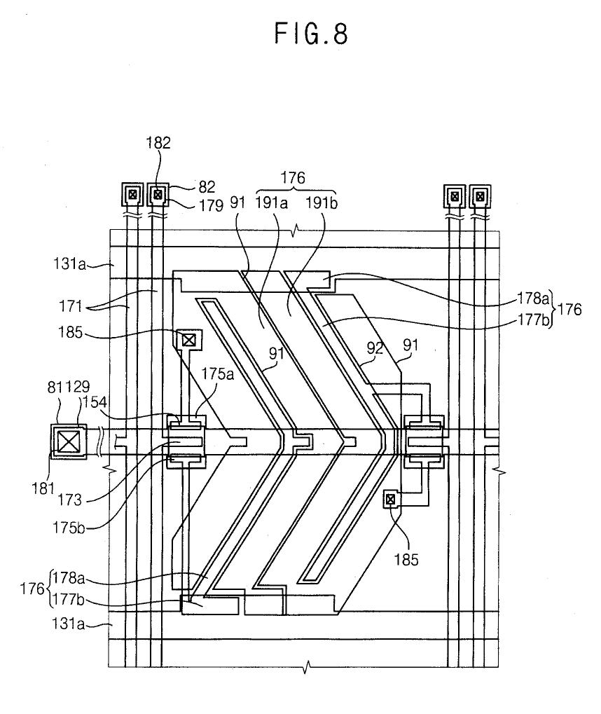

FIG. 8 is a plan view illustrating a display device in accordance with a fifth embodiment of the present invention.

In FIG. 5, each of pixels has each of the pixel electrodes 191 (shown in FIG. 5). However, in FIG. 8, each of pixel electrodes 191 is comprised of a plurality of sub-pixel electrodes 191a and 191b.

Referring to FIG. 8, each of the pixel electrodes 191 is divided into a first sub-pixel electrode 191a and a second sub-pixel electrode 191b. The first and second sub-pixel electrodes 191a and 191b may be independently operated through different switching elements. Alternatively, first and second pixel voltages applied to the first and second sub-pixel electrodes 191a and 191b may be electrically coupled. The first and second pixel voltages applied to the first and second sub-pixel electrodes 191a and 191b may have opposite polarity with respect to the common voltage.

When the pixel electrode 191 is divided into the first and second sub-pixel electrodes 191a and 191b, color difference between different viewing angles may be decreased. For example, the first and second pixel voltages applied to the first and second sub-pixel electrodes 191a and 191b are controlled to minimize the arrangement difference of the liquid crystal molecules of the liquid crystal layer 3 along the viewing angle, thereby decreasing the color difference between the different viewing angles.

In another example embodiment, the first and second sub-pixel electrodes 191a and 191b may have substantially the same structure. For example, the direction control electrode 176 may be overlapped with only one of the first sub-pixel electrode 191a and the second sub-pixel electrode 191b. When the direction control electrode 176 is overlapped with only one of the first sub-pixel electrode 191a and the second sub-pixel electrode 191b, the first and second pixel voltages applied to the first and second sub-pixel electrodes 191a and 191b may have substantially the same polarity with respect to the common voltage.

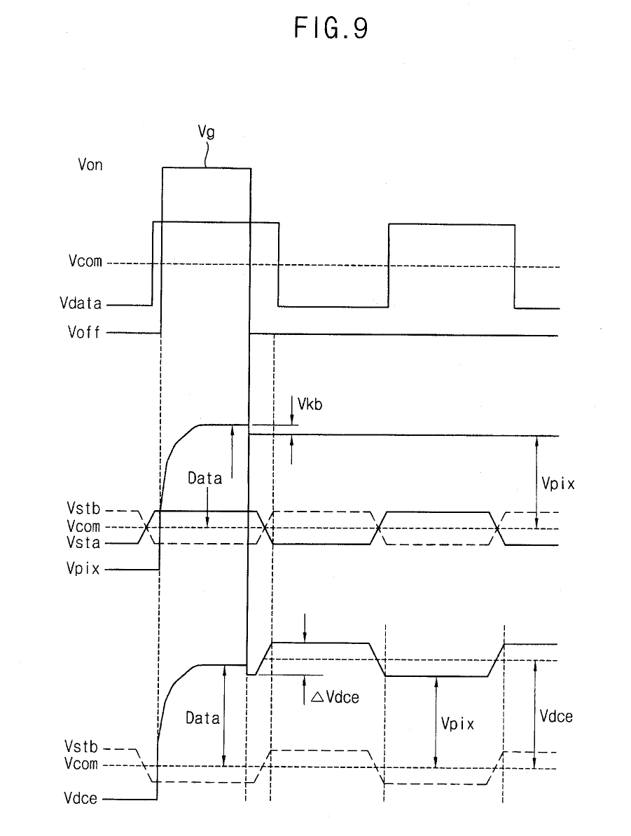

Hereinafter, an operation of an LCD device in accordance with one embodiment of the present will be explained with reference to FIG. 9.

FIG. 9 is a timing diagram illustrating signals applied to a display device in accordance with one embodiment of the present invention.

Referring to FIG. 9, a level of each of a data voltage Vdata and first and second storage voltages Vsta and Vstb is inverted with respect to a reference voltage that is a common voltage Vcom. The levels of the first and second storage voltages Vsta and Vstb may be substantially symmetric or opposite to each other with respect to the common voltage Vcom.

When a gate signal Vg is a gate-off voltage Voff, the levels of the first and second storage voltages Vsta and Vstb are inverted.

When the gate signal Vg is a gate-on voltage Von, a pixel electrode and a direction control electrode are charged by the data voltage Vdata that is transmitted through the data line. When the gate signal Vg is changed into the gate-off voltage Voff, the levels of the pixel voltage Vpix and the direction control voltage Vdce are decreased toward a kickback voltage Vkb, and the pixel voltage Vpix maintains a constant level regardless of the variation of the first and second storage voltages Vsta and Vstb. However, when the gate signal Vg is changed into the gate-off voltage Voff, the direction control voltage Vdce is changed with respect to the variation of the second storage signal Vstb, after the levels of the pixel voltage Vpix and the direction control voltage Vdce are decreased toward the kickback voltage Vkb. The pixel electrode 191 (shown in FIG. 2) is overlapped with the first and second storage lines Sa and Sb (shown in FIG. 2), so that the level of the pixel electrode 191 is not changed by the variation of the first and second storage voltages Vsta and Vstb. However, the direction control electrode 176 is overlapped with the second storage line Sb to be changed in response to the variation of the second storage voltage Vstb.

Before the second storage voltage Vstb is changed, the data voltage Vdata and the second storage voltage Vstb may have opposite polarities with respect to the common voltage Vcom. After the second storage voltage Vstb is changed, the data voltage Vdata has substantially the same polarity as the second storage voltage Vstb. The direction control voltage Vdce may have greater level than the pixel voltage Vpix with respect to the common voltage Vcom based on the variation of the second storage voltage Vstb.

The direction control voltage Vdce has a periodic value between an original voltage Vpix and an increased voltage Vpix+Vdce. Therefore, a voltage difference between the direction control voltage Vdce and the common voltage Vcom may be greater than a voltage difference between the pixel voltage Vpix and the common voltage Vcom. A relationship between the levels of the direction control voltage Vdce and an average level Vdcea is represented by Equation 1.

Vdcea=Vpix+Vdce/2 [Equation 1]

According to the present invention, a voltage difference between the direction control voltage and a reference voltage is greater than a voltage difference between the pixel voltage and the reference voltage. Thus, a viewing angle of the display device is increased, although the display device does not have a slit of the common electrode or a protrusion.

This invention has been described with reference to the example embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display substrate comprising:
first and second storage electrodes;
a pixel electrode including a slit, the pixel electrode overlapping the first and second storage electrodes; and
a direction control electrode positioned in a region in an alignment with the slit, at least a portion of the direction control electrode overlapping at least a portion of the second storage electrode.

2. The display substrate of claim 1, wherein first and second storage voltages having opposite phases to each other are applied to the first and second storage electrodes, respectively.

3. The display substrate of claim 2, wherein a pixel voltage is applied to the direction control electrode, and a level of a voltage applied to the direction control electrode is changed with respect to a variation of the second storage voltage.

4. The display substrate of claim 3, wherein a voltage difference between a reference voltage and an average level of a voltage applied to the direction control electrode is greater than a voltage difference between the reference voltage and the pixel voltage applied to the pixel electrode.

5. The display substrate of claim 1, wherein the pixel electrode and the direction control electrode comprise a transparent conductive material and an opaque conductive material, respectively, and the pixel electrode and the direction control electrode are formed from different layers.

6. The display substrate of claim 1, wherein the pixel electrode and the direction control electrode comprise a transparent conductive material, and the pixel electrode is formed from a same layer as the direction control electrode.

7. The display substrate of claim 1, further comprising:
a first switching element operative to apply a pixel voltage to the pixel electrode; and
a second switching element operative to apply the pixel voltage to the direction control electrode.

8. The display substrate of claim 1, wherein the pixel electrode includes a plurality of slits, and the direction control electrode is positioned in a region corresponding to a portion of the slits.

9. The display substrate of claim 8, wherein the direction control electrode is positioned in less than all of the slits.

10. The display substrate of claim 1, wherein an end of the direction control electrode is surrounded by the pixel electrode.

11. A display substrate comprising:
first and second storage electrodes;
first and second sub-pixel electrodes overlapped with the first and second storage electrodes, first and second slits being formed through the first and second sub-pixel electrodes, respectively;
a first direction control electrode positioned in a region corresponding to the first slit, at least a portion of the first direction control electrode overlapping at least a portion of a first electrode of the first and second storage electrodes; and
a second direction control electrode positioned in a region corresponding to the second slit, at least a portion of the second direction control electrode overlapping at least a portion of a second electrode of the first and second storage electrodes.

12. The display substrate of claim 11, wherein a first pixel voltage applied to the first sub-pixel electrode has a polarity opposite to a second pixel voltage applied to the second sub-pixel electrode.

13. The display substrate of claim 11, wherein a first pixel voltage applied to the first sub-pixel electrode has substantially the same polarity as a second pixel voltage applied to the second sub-pixel electrode.

14. The display substrate of claim 11, wherein at least one of the first and second sub-pixel electrodes has a plurality of slits, and the first direction control electrode or the second direction control electrode is positioned in a region in an alignment with a portion of the slits.

15. The display substrate of claim 14, wherein the first direction control electrode or the second direction control electrode is not formed in a region corresponding to a remainder of the slits, and the slits corresponding to the first or second direction control electrode and the slits not corresponding to the first or second direction control electrode are alternately arranged.

16. The display substrate of claim 11, wherein an end portion of the first direction control electrode and an end portion of the second direction control electrode are surrounded by the first and second pixel electrodes, respectively.

17. A display device comprising:
a first substrate comprising:
first and second storage electrodes;
a pixel electrode including a slit, the pixel electrode overlapping the first and second storage electrodes; and
a direction control electrode positioned in a region in an alignment with the slit, at least a portion of the direction control electrode overlapping at least a portion of the second storage electrode;
a second substrate spaced apart from the first substrate, the second substrate including a common electrode; and
a liquid crystal layer interposed between the first and second substrates, the liquid crystal layer being vertically aligned in the absence of an electric field.

18. A method of driving a display device, the method comprising:
applying a pixel voltage to a pixel electrode having a slit and a direction control electrode positioned in a region in alignment with the slit;
changing levels of a first storage voltage applied to a first storage electrode and a second storage voltage applied to a second storage electrode, the first and second storage electrodes being overlapped by the pixel electrode; and
changing a level of a voltage applied to the direction control electrode in response to a variation of the second storage voltage applied to the second storage electrode.

19. The method of claim 18, wherein before the second storage voltage is changed, the pixel voltage has an opposite polarity to the second storage voltage with respect to a reference voltage, and
wherein after the second storage voltage is changed, the pixel voltage has substantially the same polarity to the second storage voltage with respect to the reference voltage.

20. The method of claim 19, wherein a voltage difference between the reference voltage and an average level of a voltage applied to the direction control electrode is greater than a voltage difference between the average voltage and the pixel voltage.
